(19) United States
(12) Patent Application Publication
(10) Pub. No.: US 2006/0182552 A1
(43) Pub. Date: Aug. 17, 2006

(54) Warehousing system

(76) Inventors: Qi Fen Jiang, Richmond Hill (CA); Zhou Min Ni, Greenboro, NC (US)

Correspondence Address: DAVID W. WONG, 46 WILLOWBROOK ROAD, THORNHILL, ON, L3T 4W9, CA

(21) Appl. No.: 11/040,917

(22) Filed: Jan. 24, 2005

(51) Int. Cl. B65G 1/00

(52) U.S. Cl. 414/278

(57) ABSTRACT

Storage frames having multiple columns and rows of storage bins may be provided in the warehouse. Support bars are provided in each row of the storage bins for supporting a load package of goods place on a pallet to locate above the bottom of the bins. An upper carriage is movable along the access aisle between two storage frames. The upper carriage is connected by cable to a lower support carriage which is movable along the access aisle in unison with the upper carriage. A transporter is movable on said lower support carriage and space between the pallet and the bin bottom of each row of storage bin. The lower support carriage may be elevated to any select level of the storage bin for placing or retrieving a selected load package in or from any designated storage bin of the storage frames.

### BACKGROUND OF THE INVENTION

1. Field of the Invention

This invention relates to a warehousing system and more particularly to a high speed automatic warehousing system with maximum efficient use of the storage space in the warehouse.

2. Background Art

In a warehouse, storage frames consisting of a plurality of rows and columns of multi-level shelves located between a plurality of access aisles are commonly provided for the storage of load packages of goods which are placed on individual pallets and transported and placed in selected open bins of the shelves with a fork lift truck. To retrieve a particular piece of load package from the storage, the fork lift truck must travel in the access aisles to the particular row of storage frame and then raised the fork arms to the particular level so as to engage the fork arms with the particular pallet supporting the particular piece of load package in the open bin and removing it therefrom and then transporting it to a desired location. Such storage and retrieval warehousing arrangement is highly labor intensive and time consuming to carry out. Furthermore, since relatively wide access aisles must be provided between adjacent rows of the storage frame in order to allow sufficient room for the manoeuver of the fork lift truck to reach a selected storage bin. For a warehouse of identical goods, two access aisles may be provided for a multiple columns of shelves so that the goods may be placed in a selected row of the multiple columns of storage bins by placing them from one aisle to fill the storage bins in that row and then retrieving them, one at a time, from the opposite aisle. However, such operation is not feasible for a warehouse for a variety of different goods and that a selected piece of the goods must be stored in or retrieved from a particular storage bin of the shelving in which only the shelves immediately adjacent to the aisle may be accessed by the fork lift truck, this requirement may only be achieved by providing only two adjacent back-to-back columns of shelving of storage bins in the warehouse between two access aisles so that the fork lift truck may access the selected bin of each row of shelving for placing or retrieving a selected piece of goods only from the row of storage bins adjacent to the access aisle. Therefore, many rows of access aisles must be provided in the warehouse between all two adjacent back-to-back columns of shelving of storage bins. Such arrangement is highly inefficient in utilizing the usable storage space of goods in the warehouse.

Attempts have been made by reducing the width of the access aisles and special transport vehicles movable along tracks are provided in each access aisle of each level of shelving so that transport vehicles are provided in all level for transporting pieces of goods to selected storage bins located adjacent to the access aisle and to retrieve it therefrom. Such system increases the usable goods storage space of the warehouse by reducing the width of the access aisles. However, still only two adjacent back-to-back columns of goods storage shelving bins may be provided if the warehouse is used for storing a variety of different types of goods since the transport vehicle may still only access the goods in the single column of shelving bins located adjacent to the two sides of the aisle in the warehouse. Furthermore, it is extremely costly and complex in providing the plurality of tracks in the plurality of levels of storage frame for the transport vehicles to operate in all the different levels of the storage frame and the operation of such system is far too complex.

### SUMMARY OF THE INVENTION

It is a principal object of the present invention to provide a warehouse system which permits a load package of goods to be stored and retrieved from any selected storage bins in a multiple columns and rows of multi-levels of goods storage shelving bins such that a plurality of columns and rows of bins may be provided to maximize the efficient use of the warehouse space for goods storage.

It is another object of the present invention to provide a fully automatic warehouse system in which a selected piece of load package of goods may be stored and retrieve from any selected location of the multiple columns and rows of shelving bins.

It is another object of the present invention to provide a warehouse system in which the goods may be stored and retrieved with a high speed.

It is another object of the present invention to provide a warehouse system in which the width of the access aisle is equal to that of the storage bins.

It is still another object of the present invention to provide a warehouse system which is relatively simple in construction and operation.

It is yet another object of the present invention to provide a warehouse system which lends itself to electronic and computer control for its operation.

### BRIEF DESCRIPTION OF THE DRAWINGS

Other objects and advantages of te present invention will become more apparent from the following detailed description of the preferred embodiments thereof in connection with the accompanying drawings, in which

FIG. 1 is a perspective side elevation view of the warehouse system of the present invention showing two storage frames having four levels of multiple columns and rows of shelving bins constructed adjacent to an access aisle.

FIG. 2 is an enlarged partial perspective front elevation view a storage bin of the storage frame having an open front adjacent to the access aisle according to the present invention.

FIG. 3 is an isolated partial top sectional view along section line III-III of FIG. 2 showing parallel pairs of load support bars, rail bars, and conductive bus bars provided at the bottom of each storage bin.

FIG. 4 is a perspective top elevation view of the upper carriage movable along running rails provided on the top bars of the storage frame adjacent to the access aisle according to the present invention.

FIG. 5 is a perspective side elevation of the upper carriage.

FIG. 6 is a perspective front elevation view of the lower support carriage movable along the access aisle between adjacent storage frames according to the present invention.

FIG. 7 is a perspective side elevation view of the lower support carriage.

FIG. 8 is a perspective top elevation of the platform of the lower support carriage.

FIG. 9 is the perspective side elevation of the auxiliary rear platform of the lower support carriage.

FIG. 10 is an enlarged isolated partial sectional side view of the pivot arm provided along the side edges of the lower support carriage.

FIG. 11 is a sectional bottom view of the rotatable shaft of the pivotal arm showing the mechanism for positioning it either flush with the side edge of the lower support carriage or perpendicular thereto.

FIG. 12 is a perspective top elevation view of the goods transporter movable on the lower support carriage and in any row of storage bins in the space between the bottom of the bin and the pallet supporting the load package.

FIG. 13 is a partial sectional side elevation view of the transporter along section line XIII-XIII of its rotary wheels of FIG. 12.

FIG. 14 is a partial sectional side elevation view of the transporter along the section line XIV-XIV of its drive wheels of FIG. 12.

FIG. 15 is an isolated partial sectional side view of the rotatable and raisable turn table and the positioning guide rods along the section line XV-XV of the transporter of FIG. 12.

FIG. 16 is a section side view of the rotatable and raisable turn table of the transporter along section line XVI-XVI of FIG. 12.

### DETAILED DESCRIPTION OF THE PREFERRED EMBODIMENTS

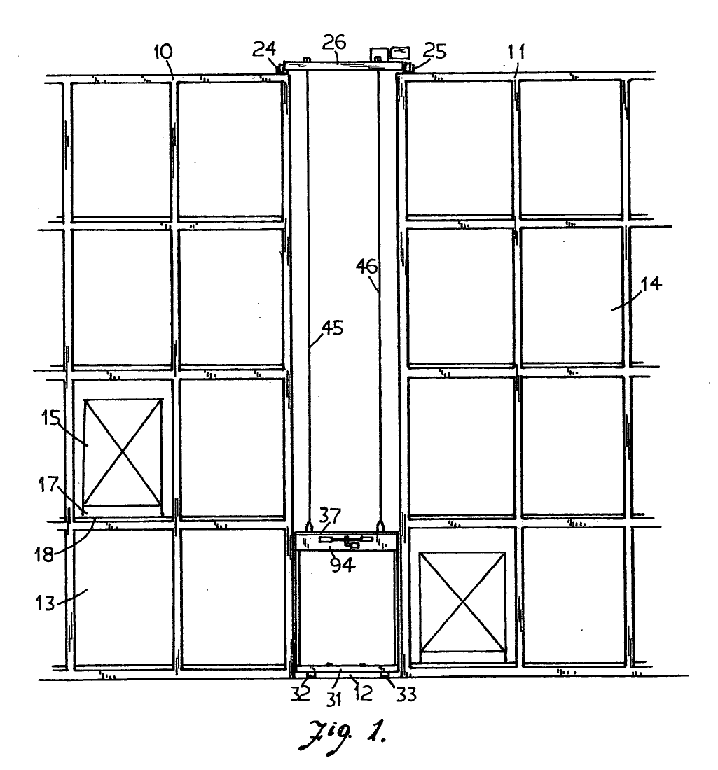

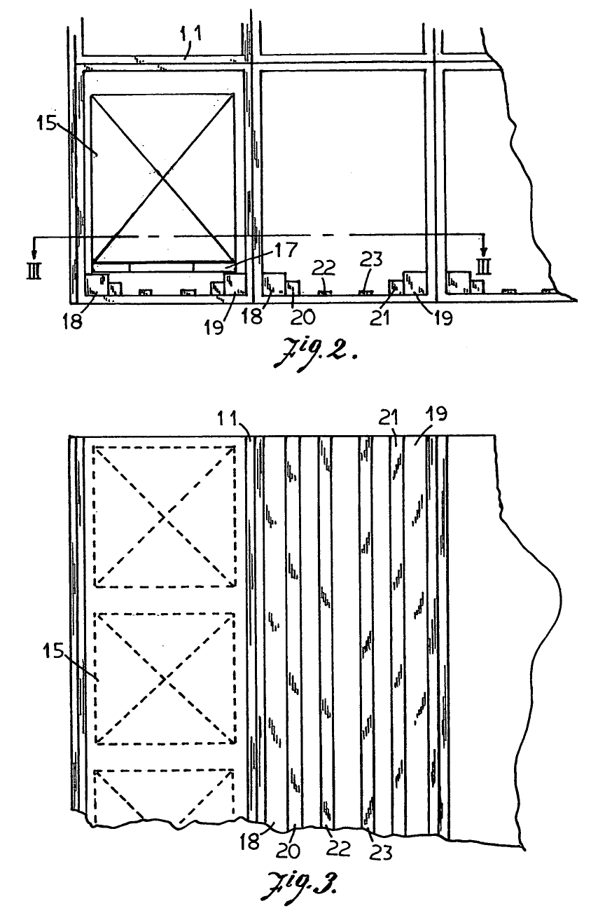

With reference to the drawings in which like reference numerals designate corresponding parts in the several views. For simplicity of illustration as shown in FIG. 1, two four levels multiple columns storage frames 10 and 11 are located adjacent to an access aisle 12 in a warehouse according to the present invention. The storage frames 10 and 11 have a plurality of parallel columns and rows of storage bins 13 and 14 respectively in each level. Each row has a plurality of storage bins located in tandem, and the front storage bins 13 and 14 are open to the access aisle 12 such that a plurality of load packages of goods 15 may be placed in or removed from the storage bins through the front opening 16 of the front storage bin adjacent to the access aisle 12. The load packages of goods 15 are supported on pallets 17 to facilitate their handling. The width of the storage bin is slightly larger than the width of the pallet 17. Two elongated support bars 18 and 19 preferably having a generally rectangular cross sectional shape are located along the bottom corners of the storage bins in each row of each level for supporting the pallets 17 with a load package of goods 15 resting on each pallet. Two elongated rail bars 20 and 21 having smaller cross sectional dimensions than the support bars 18 and 19 are located juxtaposed to the support bars 18 and 19 respectively such that the upper surface of the rail bars 20 and 21 are located below the top surface of the support bars 18 and 19. Two elongated parallel and spaced electrically conductive bus bars 22 and 23 are located at the center of the bottom of the storage bins in all rows.

Running rails 24 and 25 are provided at the top frame member of the storage frames 10 and 11 and located adjacent to the access aisle 12. These running rails 24 and 25 extend throughout the entire length of the storage frames along the access aisle 12.

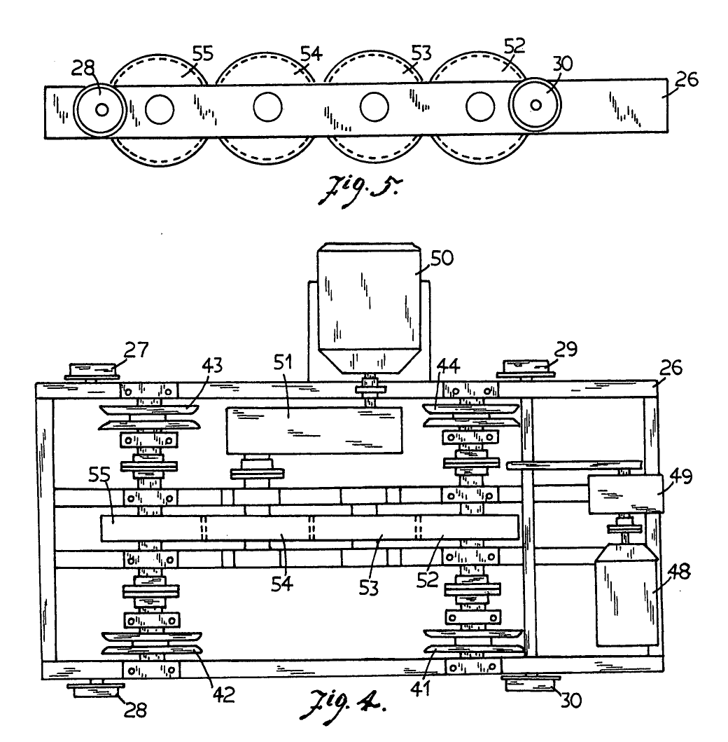

An upper carriage 26 as best shown in FIG. 4 is slidably located at the top of the access aisle 12. The upper carriage 26 is provided with rotary wheels 27 and 28, and drive wheels 29 and 30 as shown in FIG. 4, which are rotatably engaged with the running rails 24 and 25 such that the upper carriage 26 is movable along the storage frames on top of the access aisle 12.

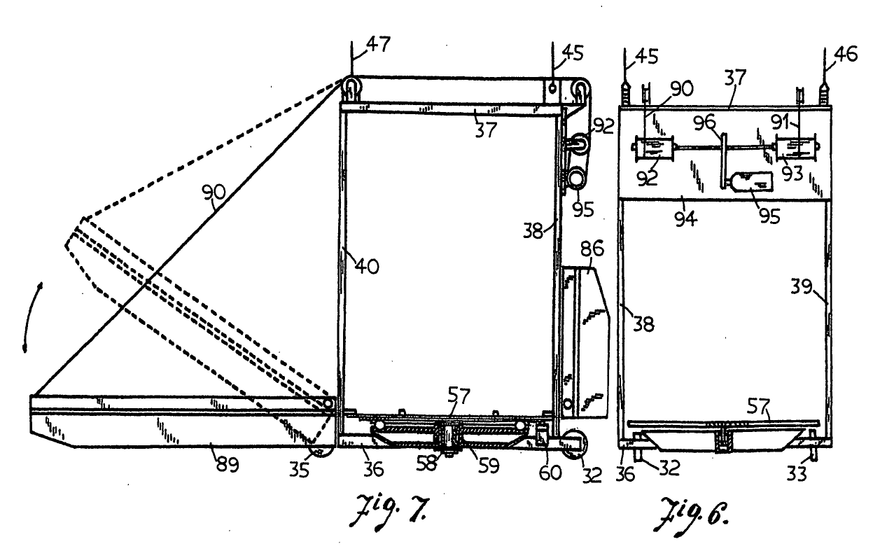

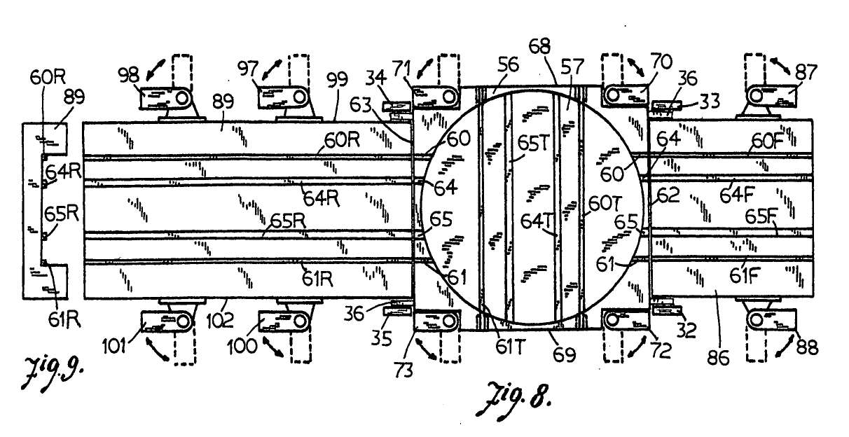

A lower support carriage 31 is located in the access aisle 12. The lower support carriage 31 are provided with drive wheels 32, and 33, and rotary wheels 34 and 35 as shown in FIG. 8 such that the lower support carriage 31 is movable along the floor of the access aisle 12 with the drive wheels 32 and 33 operated by a drive motor. Running rails may be provided on the floor of the access aisle 12 to ensure the linear movement of the lower support carriage 31 relative to the storage frames 10 and 11. The lower support carriage 31 is in the form of a rectangular cage consisting of a lower rectangular frame 36 and an upper rectangular frame 37. The upper and lower rectangular frames 36 and 37 are connected together by four vertical corner posts so that the cage is open on all four sides. Three of the vertical corner posts 38, 39 and 40 are visible in FIGS. 6 and 7.

The lower support carriage 31 and top carriage 26 are connected to each other by four elongated steel cables with their bottom end connected to the upper frame 37 of the lower support carriage 31 and their top end are connected to cable winding reels 41, 42, 43 and 44 located in the upper carriage 26. Three cables 45, 46 and 47 are visible in FIGS. 1, 6 and 7. The drive wheels 29 and 30 of the upper carriage 26 are driven by an electric motor 48 through coupling gear linkage 49. The operation of the electric motor 48 of the upper carriage 26 and the drive motor for drive wheels 32 and 33 of the lower support carriage 31 are controlled by remote electronic means such that the two carriages are moving in unison along the access aisle 12. A second electric motor 50 located in the upper carriage 26 is also operative by the remote electronic control to operate the cable winding reels 41, 42, 43 and 44 through gear linkage 51 and coupling gears 52, 53, 54 and 55 for elevating the lower support carriage 26 to any selected level to align with a selected row of storage bins of the storage frames 10 and 11.

The lower support carriage 31 has a generally square or rectangular main platform 56 removably disposed on top of the lower frame 36. The total height of the main platform 56 together with the lower frame 36 of the lower support carriage 31 is less than the height of the pallet support bars 18 and 19 located at the bottom corners of the storage bins. A rotatable turn table 57 is located in an opening formed at the center of the main platform 56. The turn table 57 is preferably circular in shape as shown in FIG. 8 and it is rotatable relative to the main platform 56 on a vertical shaft 58 rotatably mounted in a vertical sleeve housing 59 integrally formed in the body of the main platform 56 so that the turn table 57 is rotatable by a rotary motor 60 mounted on the lower frame 36 with rotary gears engaging with the periphery of the turn table 57. When a turn table other than circular in shape is used, the turn table 57 may be rotated with the rotary motor coupled to vertical shaft 58. The turn table 57 is rotatable by a turn of 90 degree with the operation of the rotary motor by the remote electronic control. Two parallel rails 60 and 61 extends from the front edge 62 of the main platform 56 to the front edge of the center circular opening and from the opposite edge of the center circular opening to the rear edge 63 of the main platform 56. Also, two parallel electrically conductive bus bars 64 and 65 are provided on the main platform 56 in the similar manner and preferably located between the parallel rails 60 and 61 as best shown in FIG. 8. Similar parallel rails 60T and 61T, and conductive bus bars 64T and 65T are formed in a diametrical manner on the turn table 57 such that when the rotatable turn table 57 is rotated by 90 degree as shown in FIG. 8, the parallel rails 60T and 61T and the conductive bus bars 64T and 65T are perpendicular to the two sides 68 and 69 of the main platform 56. The rails 60T and 61T and bus bars 64T and 65T will align with the rails 60 and 61 and bus bars 64 and 65 respectively when the turn table 57 is rotated back through a 90 degree turn. Pivotal arms 70 and 71 are provided at the corners of the side edge 68 of the main platform 56 and similarly two pivotal arms 72 and 73 are provided at the corners of the other side edge 69. The pivotal arms 70, 71, 72 and 73 are operative selectively to lie flush within the corners of the main platform 56 or to extend outwards, as shown in dotted lines, to perpendicular to the side edges 68 and 69 respectively. As best shown in FIG. 8, each pivotal arm consists of a cantilever arm 74 having a vertical rotatable shaft 75 mounted adjacent to the main platform 56. The rotatable shaft 75 is rotatably engaged downward in a vertical sleeve housing 76 formed in the body of the main platform 56. A rectangular pivot board 77 is mounted perpendicular on the side wall of the rotatable shaft 75. Two push rods 78 and 79 are slidably mounted in two diametrically positioned sleeve housings 80 and 81 integrally formed on the vertical sleeve housing 74. The push rods 78 and 79 are operative to push upon the pivot board 77 in order to turn the pivotal arm between the position flush with the main platform 56 or perpendicular thereto. A pneumatic clamp consisting of two pneumatic means 82 and 83 are mounted in a spaced fashion at the underside of the free end portion of the cantilever arm 74. The pneumatic means 82 and 83 have plates 84 and 85 horizontally movable relative to one another to form a clamp at the underside of the cantilever arm 74.

A front auxiliary platform 86 may be pivotally and removably mounted to the front edge 62 of the main platform 56 and it may be pivoted upwards as shown in FIG. 7 to position upwards relative to the main platform 56 for storage purposes or downwards to position on the same plane as the main platform 56 so as to form an extension platform in front of the main platform 56. The front auxiliary platform 86 preferably has a length equal to that of the main platform 56. Parallel rails 60F and 61F and bus bars 64F and 65F are also formed on the top surface of the front auxiliary platform 86 which provide extensions to the rails 60 and 61 and to bus bars 64 and 65 of those on the main platform 56. Two pivotal arms 87 and 88 are provided at the two sides of the front auxiliary platform 86. These pivotal arms 87 and 88 are pivotable to a position parallel with the front auxiliary platform 86 or to a position perpendicular to the latter as shown in dotted lines in FIG. 8 and they are similar in structure to the pivotal arms 70, 71, 72 and 73 on the main platform 56.

A rear auxiliary platform 89 may also be pivotally and removably mounted to the rear edge 63 of the main platform 56. The rear auxiliary platform 89 may be positioned horizontally on the same plane as the main platform 56 so as to provide a rear extension of the main platform 56. For a warehouse having three tandem storage bins in each row, a rear auxiliary platform having a length twice as long as the main platform 56 may be provided and it may be pivoted to a raised position as shown in dotted line in FIG. 7 by steel cables 90 and 91 which are windingly connected to winding drums 92 and 93 mounted on a top front panel 94 located at the top front portion of the cage of the lower support carriage 31. The winding drums 92 and 93 are operative by an electric motor 95 through a rotating link 96. Parallel rails 60R and 61R and bus bars 64R and 65R are provided on the top surface of the rear auxiliary platform 89 and they are aligned with the rails 60 and 61 and bus bars 64 and 65 when the rear auxiliary platform 89 is lowered to the horizontal position.

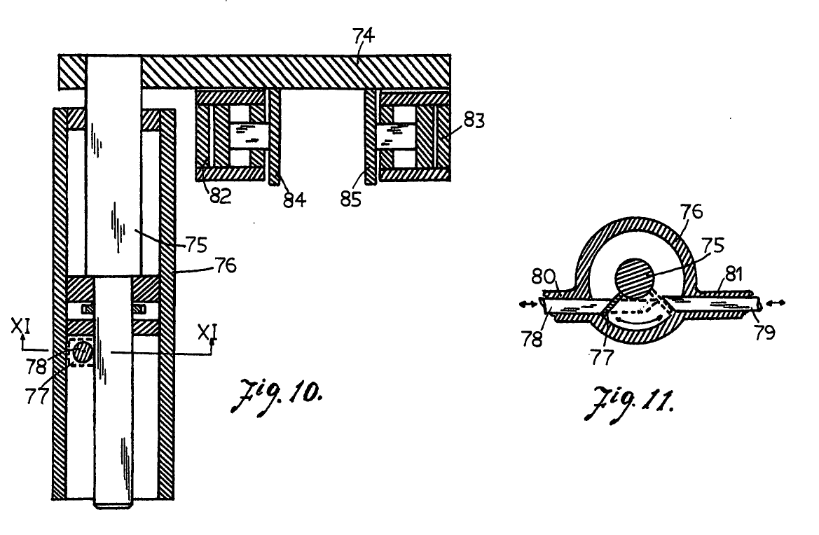

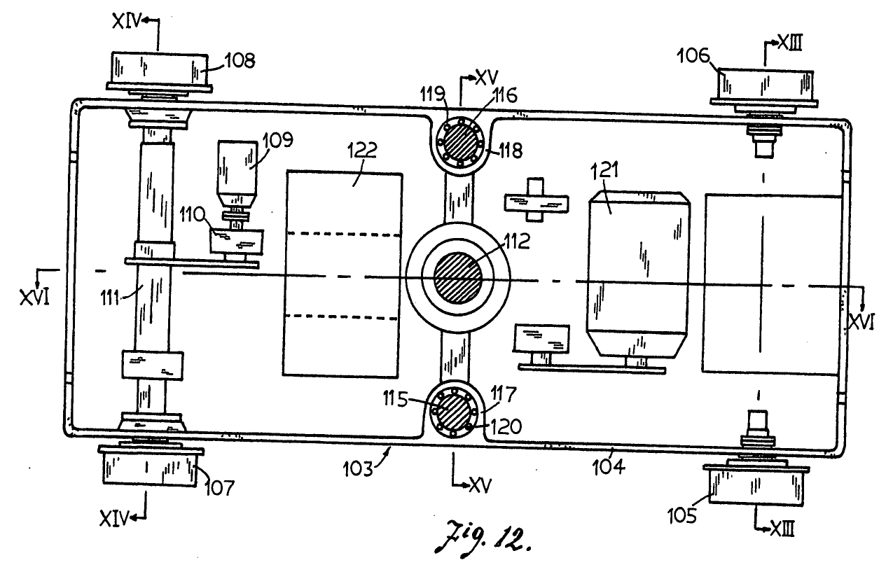

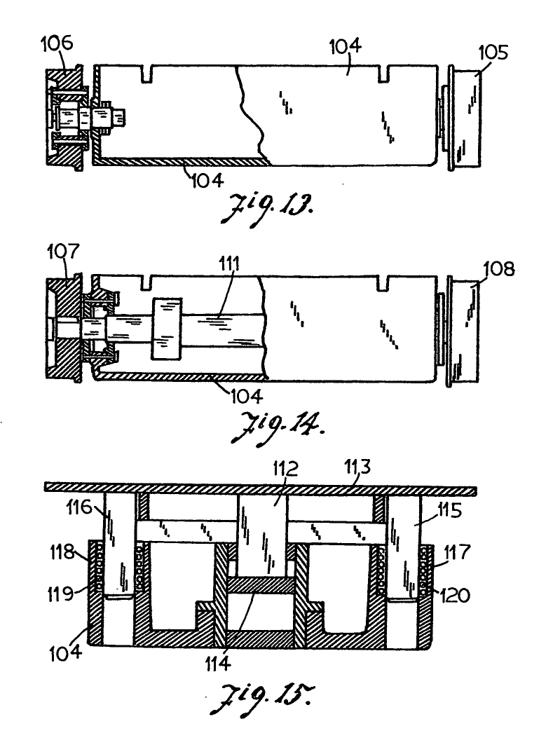

Both the front auxiliary platform 86 and rear auxiliary platform 89 have a cross sectional shape as shown in FIG. 9 with the side edge portions having cross sectional dimensions identical to those of the support bars 18 and 19 located at the bottom corners of the storage bins. The width of the auxiliary platforms 86 and 89 are similar to the width of the storage bins such that a load package of goods may be placed on these platforms with the load supporting pallet resting on their side edge portions.

Pivotal arms 97 and 98 are formed on one side edge 99 of the rear auxiliary platform 89, and pivotal arms 100 and 101 are formed on its other side edge 102. The pivotal arms 97, 98, 100 and 101 are similar in construction to that of the pivotal arms 87 and 88 of the front auxiliary platform 86 and they also may be positioned either flush with the side edge of the rear auxiliary platform 89 or perpendicular thereto as shown in the dotted lines in FIG. 8.

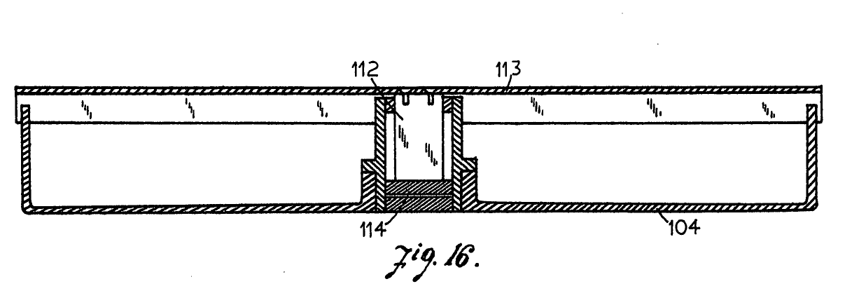

A transporter 103 is provided for transporting goods to or from the storage bins 16. The transporter 103 has a generally rectangular frame 104 with two rotary wheels 105 and 106, and drive wheels 107 and 108 rotatably mounted thereon. The drive wheels 107 and 108 are driven by an electric drive motor 109 through a coupling link 110 coupled to the drive shaft 111 of the drive wheels 107 and 108. A pneumatically operative slidable shaft 112 is slidably mounted vertically at the center of the transporter 101. A horizontal board 113 is mounted on top of the slidable shaft 112 such that the slidable shaft 112 may be operated by pneumatic means 114 to elevate the horizontal board 113 to an upper position as shown in FIG. 15 or to a lower position as shown in FIG. 16 in which the horizontal board 113 is resting on the frame 104. Two vertical positioning rods 115 and 116 are mounted to the underside of the horizontal board 113 and are slidably engaged within two slidable sleeve housings 117 and 118 to guide and to provide stability to the elevation and lowering movements of the horizontal board 113. Ball bearings 119 and 120 may be provided in the sleeve housings 117 and 118 to enhance the slidable movement of the positioning rods 115 and 116 relative to the sleeve housings 117 and 118. The pneumatic means 114 may be operated by pump motor 121 mounted on the transporter 101. The operation of the drive motor 109 and the pump motor 121 are provided by electrical control 122 and electrical contacts (not shown) are provided at the underside of the electrical control 122, which are in contact with the bus bars 64T and 65T when the transporter 103 is located on the turn table 57 with the rotary wheels 105 and 106 and drive wheels 107 and 108 engaging with the rails 60T and 61T.

The transporter 103 is movable along the main platform 56, the turn table 57, the front auxiliary platform 86 and the rear auxiliary platform 89 when they are all positioned on the same horizontal plane. Furthermore, since the transporter 103 has a total height less than the height of the support bars 18 and 19, it is also movable within all rows of storage bins in the space between the goods supporting pallet 17 and the bottom of the storage bins, with the wheels of the transporter 103 engaging with the rail bars 20 and 21 and the electrical contacts in contact with the bus bars 22 and 23 located at the bottom of the storage bins. The bus bars convey the low voltage electrical signals to the transporter 103 for its operation.

The exemplary embodiment shown is particularly suitable for storing and retrieving load packages from storage frames having three storage bins located in tandem in each row adjacent to the access aisle. In operation, for example, to place a load package of goods in the third storage bin in a selected row of a selected level of the storage frame in which two front storage bins in that row are already occupied by other load packages, the upper carriage 26 is moved to the front end of the storage frames 10 and 11 and the lower support carriage 31 is also moved in unison to the front end of the access aisle 12 with all the platforms positioned in a horizontal plane. A load package of goods supported on a pallet is placed on the transporter 103 such as by a fork lift truck. The transporter 103 is operated to move the load package to the turn table 57 of the lower support carriage 31. Both carriages 26 and 31 are then operated in unison to move along the access aisle 12 to the selected column. The lower support platform 31 is raised to the selected row of the selected level. The pivotal arms 70, 71, 72, 73, 87, 88, 97, 98, 100 and 101 are operated to pivot outwards and then lowered so that the clamps under the pivotal arms are pneumatically operated to clamp onto the horizontal frame member of the storage frames at that level. The lower support platform 31 will thus be firmly mounted to the storage frames. After the lower support platform 31 has been firmed mounted in place, the transporter 103 is operated to move and to place the load package to the front auxiliary platform 86. The transporter 103 is returned to the turn table 57 which is then turned 90 degrees such that the transporter 103 is now aligned with the storage bins in that row. The transporter 103 is operated to move to the position directly under the first load package in the first storage bin. The horizontal board 113 of the transporter 103 is raised to lift that first load package from the support bars 18 and 19 of that first storage bin and then to move it out to the main platform 57. The turn table 57 is operated to turn 90 degrees so that the transporter 103 may move the first load package to the rear end position of the rear auxiliary platform 89 and temporarily leaving the first load package at that position, and the transporter 103 is then returned to the row to remove the second load package from the second storage bin and transporting and temporarily placing it at the remaining position of the rear auxiliary platform 89. The transporter 103 may then move the intended load package from the front auxiliary platform 86 to place it in the intended third storage bin. Thereafter, the second and first load packages are returned to the original second and first storage bins sequentially by the transporter 103.

When a load package is to be placed in an empty front storage bin, the front and rear auxiliary platforms 86 and 89 may be removed and only the main platform 56 is used to transport and deposit the load package to such empty front storage bin.

For a warehouse having more than three storage bins located in tandem in each row, a longer rear auxiliary platform more than twice the length of the main platform 56 may be provided, and such long rear auxiliary platform may be suspended by a second upper carriage located in tandem behind the first upper carriage which is connected to the lower support platform. The first and second upper carriages are moved in unison with one another so that the long rear auxiliary platform is always juxtapose to the main platform to facilitate the temporary placing of load packages thereon.

The entire placement and retrieval of a load package may be electronically and remotely controlled by a computer system and the operation may be carried out with a high speed. The computer system also maintains the inventory and storage records of the goods for accurate location of the load packages of goods on the storage frames. Moreover, since the placement and retrieval process may be carried out for any selected load package in any storage bin located in any column and row of the storage frame, more than two storage bins may be provided in any row of the storage frame and any particular one of the load packages of goods of different types may be placed and retrieved in and from the system. Also, the access aisle has a width only equal to the width of the storage bins. Therefore, high density storage frames may be constructed in a warehouse with a minimum number of access aisles required so that the entire space in the warehouse for goods storage may be fully utilized.

While the present invention has been shown and described in the preferred embodiments thereof, it will be apparent that various modifications can be made therein without departing from the spirit or essential attributes thereof, and it is desired therefore that only such limitations be placed thereon as are imposed by the appended claims.

1. A warehousing system comprising,
a plurality of multi-level storage frames located on two sides of an access aisle, said storage frames having a plurality of columns and rows of storage bins in each level and each row having a plurality of storage bins located in tandem with a front storage bin open to said access aisle,
a pair of elongated support rods located at two bottom corners of bottom frame members of said rows of storage bins and adapted for supporting a plurality of pullets with each pallet having a load package of goods resting thereon and located in each one of said storage bins, said each pallet being located at a predetermined space above said bottom frame members when resting on said support rods,
an upper carriage located above said access aisle and having running wheels thereon rotatably engaged with running rails provided along top fame members of said storage frame located adjacent to said access aisle, said upper carriage being operative to move along said top frame members,
a lower support carriage having rotary wheels and adapted to move along said access aisle, said lower support carriage having a horizontal platform and a rotatable turn table located in said platform,
elongated suspending cable members connecting between said upper carriage and sad lower support carriage, and said upper carriage and said lower carriage being operative to move in unison with one another along said access aisle, said cable members being operative for elevating said lower carriage to a selected level of said storage frames, a transport member movable on said platform of said lower support carriage and in said storage bins in said predetermined space below said pallets when said platform is located adjacent to a selected level of storage bins and operative selectively for transporting a selected pallet having a selected load package of goods thereon from, said platform to a selected storage bin and retrieving from a selected storage bin a selected pallet with a selected load package of goods thereon.

2. (canceled)

3. A warehousing system according to claim 1 wherein said transporter member has a rectangular frame with rotary wheels and drive wheels mounted thereon and a vertically movable horizontal board disposed on said frame, said vertical rod being operative for moving said horizontal board vertically between an upper position and a lower position, said transporter member having a first total height higher than said support ban in said storage bins when said horizontal board is located at said upper position for rising a selected pallet above said support bars, and a second total height lower than said support bars when said horizontal board is at said lower position for depositing sad selected pallet in a selected storage bin.

4. A warehousing system according to claim 3 including a pair of spaced parallel rails located juxtaposed to said support bars, and a pair of parallel spaced electrical conductive bus bars located at said bottom of said row of storage bins, and a pair of associated rails and a pair of associated conductive bus bars located on said platform and said turn table, said associated rails and associated conductive bus bars of said turn table being selectively aligned with said rails and conductive bus bars by rotating said turn table.

5. A warehousing system according to claim 4 wherein said turn table is rotatable selectively, to align said rails and bus bars on said turn table and on said platform, and to align with associated parallel rails and parallel bus bars provided in said rows of storage bin when said turn table is turned through a 90 degree.

6. A warehousing system according to claim 5 including a plurality of pivotal arms located on two opposite sides of said platform of said lower support carriage, said lateral sides of said platform being juxtaposed to said front storage bin on said two sides of said access aisle, and being operative to lie selectively in a first position flush with side edges of said platform and a second position perpendicular of said side edges and extending outwards to rest on horizontal frame members of said storage frames for fixedly mounting said lower support fame at a selected level of said storage frame.

7. A warehousing system according to claim 6 including clamping means located at an underside of a free end portion of said pivotal arms, said clamping means being operative for securing said lower support carriage to said horizontal frame member for securely mounting said lower support carriage to said storage frames during transfer of said selected pallet with said load package of goods thereon between said lower support Gage and said storage bins by said transporter member.

8. A warehousing system according to claim 7 wherein said platform includes a main platform, a front auxiliary platform pivotally and removably mounted to a front edge of said min platform, and a rear auxiliary platform pivotally and removably mounted to a rear edge of said main platform, said front auxiliary platform and said rear auxiliary platform having a cross sectional shape and dimensions equal to cross sectional shape and dimensions of the bottom frame of said storage bins, and said rear auxiliary platform having a length at least twice of said main platform.

9. (canceled)

10. (canceled)

11. A warehousing system according to claim 8 including a vertical shaft mounted at a center of said turn table and extending downward therefrom to engage rotatably with a sleeve housing in said lower support carriage whereby said turn table is rotatable back and forth by said 90 degrees.

12. (canceled)

13. A warehousing system according to claim 11 wherein said transporter member includes vertical positioning rods mounted under said horizontal board and extending downward to engage slidably with positioning sleeves in said rectangular frame of said lower support carriage and adapted to guide and to provide stability of raising and lowering movements of said horizontal board between said upper position and said lower position.

14. (canceled)

15. A warehousing system comprising,
a plurality of multi-level storage flumes located on two sides of an access aisle in a warehouse, said storage frames having a plurality of columns and rows of storage bins in each level and each row having at least two storage bins located in tandem with a front storage bin open to said access aisle,
two elongated support bars located at two bottom corners of a bottom frame in each row of said storage bins and adapted to support a plurality of pallets with each one pallet therein supporting a load package of goods resting thereon when said load package is placed in a selected storage bin of each row whereby said pallets are located in said predetermined space above said bottom fine when resting on said support bars,
two elongated rail members located juxtaposed to said support bars in each row of said storage bins, said rail members being locate at a height lower than said support bars,
two elongated running rails mounted on a top frame member of said storage frames and located adjacent to said access aisle,
an upper carriage located on top of said access aisle and having running wheels thereon rotatably engaged with said running rails and adapted to move along said running rails above said access aisle,
a lower support carriage having a rectangular cage frame including a lower frame and an upper fire connected to one another by four vertical posts, rotary wheels and drive wheels mounted on said lower frame and adapted to move said lower support carriage along said access aisle directly below said upper carriage in unison with one another, said lower support carriage having a horizontal main platform and a rotatable turn table located in said main platform,
a front auxiliary platform pivotally and removably mounted to a front edge of said main platform, and a rear auxiliary platform pivotally and removably mounted to a rear edge of said platform, said rear auxiliary platform having a length twice of said main platform,
elongated suspension cable members connecting between said top frame of said lower support carriage and said upper carriage, a transporter member being movable on said main platform and in said predetermined space blow said pallets and transporting a selected pallet with a selected load package resting thereon to a selected storage bin, said transporter member having a horizontal board movable vertically between an upper position and a lower position, said transporter member having a first total height higher than said support bars in said storage bins when said horizontal board is at said upper position whereby said pallet with said load package is movable by said transporter member through said row of storage bins, and a second total height lower than said support bars when said horizontal board is at said lower position for depositing said load package to rest upon said support bars in said selected storage bin.

16. A warehousing system according to claim 15 wherein said transporter member has a rectangular frame with rotary wheels and drive wheels provided thereon and adapted to engage with said rail members in said row of storage bins when said transporter member is traveling through said storage bins within said predetermined space between said pallets and said bottom frame of said storage bins.
